(19) United States
(12) Patent Application Publication
(10) Pub. No.: US 2016/0129760 A1
(43) Pub. Date: May 12, 2016

(54) AIR CONDITIONING SYSTEM FOR MACHINE

(71) Applicant: Caterpillar Global Mining Equipment LLC, Denison, TX (US)

(72) Inventors: SAEID MIRZAEI, MUSKEGO, WI (US); MARK GLENDINNING, WASHINGTON, IL (US); BIJAY BAJRACHARYA, WAUKESHA, WI (US)

(73) Assignee: Caterpillar Global Mining Equipment LLC, Denison, TX (US)

(21) Appl. No.: 14/536,740

(22) Filed: Nov. 10, 2014

(51) Int. Cl. B60H 1/32; F01P 7/10

(52) U.S. Cl. CPC B60H 1/3205; B60H 1/3227; F01P 7/10

(57) ABSTRACT

An air conditioning system for a machine is disclosed herein. The machine has an engine, a radiator operably connected to the engine, and a radiator fan to generate a flow of air over the radiator. The air conditioning system includes a condenser, at least one condenser fan, a sensor, and a control unit. The condenser condenses a refrigerant and is structured and arranged to directly receive at least a portion of the flow of air generated by the radiator fan. The at least one condenser fan selectively generates a flow of air over the condenser. The sensor measures at least one of: an engine speed, a temperature of the condenser, and an airflow through the condenser. The control unit selectively controls the at least one condenser fan based on the at least one of: the engine speed, the temperature of the condenser, and the airflow through the condenser.

### TECHNICAL FIELD

The present disclosure relates generally to an air conditioning system for a machine. More specifically, the present disclosure relates to cooling of a condenser of the air conditioning system.

### BACKGROUND

Various machines, such as mining trucks, commonly employ an air conditioning system to cool air within a predefined region of the machine. The air conditioning system includes a condenser that condenses a refrigerant that flows through the condenser. The condenser of the air conditioning system is required to be cooled for efficient operation of the air conditioning system.

Conventional air conditioning systems may employ a radiator fan to cool the condenser of the air conditioning system, as well as a radiator of the machine. Since the radiator fan is used to cool both the condenser and the radiator, the radiator fan alone may be inefficient to cool the condenser. There may also be conditions, such as non-operation of the machine, when the radiator fan may not be in operation. In those situations, the radiator fan may not cool the condenser, which may result in inefficient operation of the air conditioning system.

Alternatively, the air conditioning system may employ a dedicated condenser fan to cool the condenser of the air conditioning system. The condenser fan may be sufficient to cool the condenser during normal operation. However, the condenser fan may be in operation in all operating conditions. This results in a significant waste of energy.

United States Publication, US 2014/0138077 discloses a vehicle cooling device with a front side heat exchanger (condenser) and a rear side heat exchanger (radiator). The air through the front side heat exchanger and the rear side heat exchanger is guided so that they do not interrupt operation of each other. Although this reference provides a means to cool the condenser by guidance of the air, no solution is provided to cool the condenser under various operating conditions, while saving energy.

### SUMMARY OF THE INVENTION

Various aspects of the present disclosure are directed to an air conditioning system for a machine. The machine has an engine, a radiator operably connected to the engine, and a radiator fan to generate a flow of air over the radiator. The air conditioning system includes a condenser, at least one condenser fan, a sensor, and a control unit. The condenser is adapted to condense a refrigerant. The condenser is structured and arranged to directly receive at least a portion of the flow of air generated by the radiator fan. The at least one condenser fan is adapted to selectively generate a flow of air over the condenser. The sensor is configured to measure at least one of: an engine speed, a temperature of the condenser and an air flow through the condenser. The control unit is operably connected to the sensor. The control unit is adapted to selectively control the at least one condenser fan based on the at least one of: the engine speed, the temperature of the condenser and the air flow through the condenser.

### BRIEF DESCRIPTION OF THE DRAWINGS

FIG. 1 is a perspective view of a mining truck having an air conditioning system, in accordance with the concepts of the present disclosure;

FIG. 2 is a schematic depiction of various components of the air conditioning system of FIG. 1;

FIG. 3 is a front view of the air conditioning system of FIG. 1 that illustrates the position of a condenser of the air conditioning system;

FIG. 4 is a circuit diagram of a control system of the air conditioning system that illustrates a sensor and a control unit that selectively controls a condenser fan of the air conditioning system; and

FIG. 5 is a flow chart of the control system of FIG. 4 of the air conditioning system that illustrates steps of activation and deactivation of the condenser fan.

### DETAILED DESCRIPTION

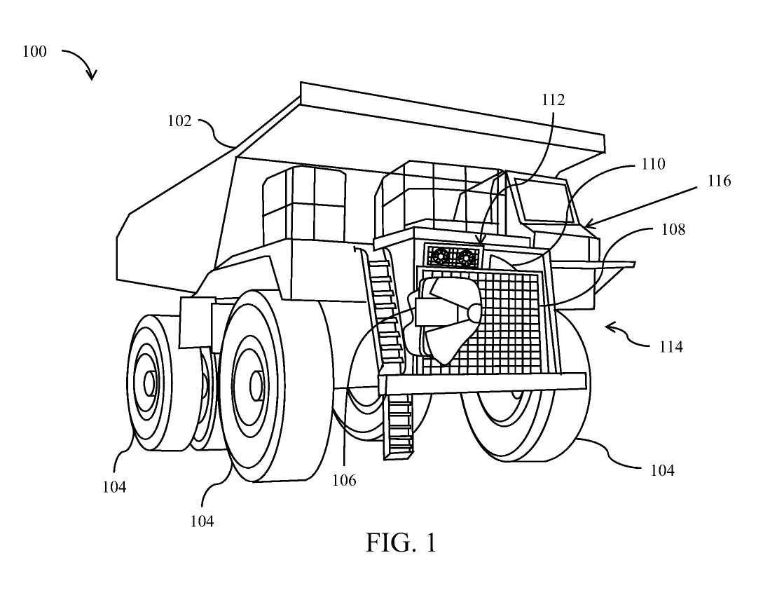

Referring to FIG. 1, there is shown a perspective view of a machine 100. Although the machine 100 depicts a mining truck, it may be contemplated that the machine 100 may be an off-highway truck, a paving machine, an excavator, a vehicle, or any other machine. The machine 100 includes a load carrying container 102 and a plurality of wheels 104, to carry load from one place to another. Moreover, the machine 100 includes an engine 106, a radiator 108, a radiator fan 110, and an air conditioning system 112.

The engine 106 may be an internal combustion engine that produces power required for running the machine 100. The engine 106 may develop heat upon continuous operation. Therefore, the radiator 108 is installed to cool the engine 106.

The radiator 108 is operably connected to the engine 106. More specifically, the radiator 108 is in fluid communication with the engine 106 and is installed along the frontal end 114 of the machine 100. The fluid communication facilitates a flow of engine coolant between the engine 106 and the radiator 108. The engine coolant is adapted to extract heat from the engine 106 and is required to be cooled in the radiator 108, before being recirculated.

The radiator fan 110 is installed proximal to the radiator 108. The radiator fan 110 is used to cool the engine coolant that flows through the radiator 108. More particularly, the radiator fan 110 is structured and arranged to generate a flow of air over the radiator 108. This flow of air transfers heat from the engine coolant in the radiator 108 to the air in the external environment.

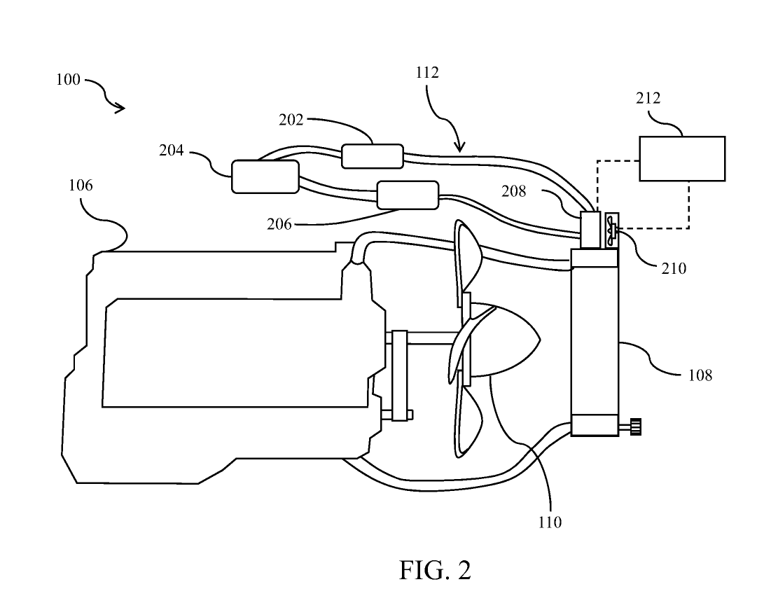

The air conditioning system 112 is installed to cool an operator cabin 116 of the machine 100. The air conditioning system 112 is installed along the frontal end 114 of the machine 100. More specifically, the air conditioning system 112 is installed proximal to the radiator 108 and the radiator fan 110. The specific arrangement of the air conditioning system 112 is best described in FIG. 2.

Referring to FIG. 2, there is shown a schematic of the machine 100 that illustrates the air conditioning system 112 installed in conjunction with the radiator 108 and the radiator fan 110. The air conditioning system 112 includes an expansion valve 202, an evaporator 204, a compressor 206, a condenser 208, and at least one condenser fan 210. The air conditioning system 112 circulates a refrigerant through the expansion valve 202, the evaporator 204, the compressor 206, and the condenser 208, in a closed loop manner.

The expansion valve 202 may be a small orifice tube that allows the refrigerant to expand to its gaseous form as the refrigerant passes through the expansion valve 202. The refrigerant is cooled as it expands to its gaseous form. The cooled refrigerant is then passed through the evaporator 204.

The evaporator 204 is in fluid communication with the expansion valve 202 and is disposed downstream of the expansion valve 202. The evaporator 204 is mainly a heat exchanger that transfers heat from the operator cabin 116 to the refrigerant that flows through the evaporator 204. Therefore, the operator cabin 116 is cooled and the refrigerant is heated up. The heated refrigerant is then passed through the compressor 206.

The compressor 206 is in fluid communication with the evaporator 204 and is disposed downstream of the evaporator 204. The compressor 206 compresses the refrigerant that passes through the compressor 206. The refrigerant retains energy as it is compressed and is therefore further heated. The refrigerant is then passed through the condenser 208 to be cooled.

The condenser 208 is in fluid communication with the compressor 206 and is disposed downstream of the compressor 206. The condenser 208 receives the refrigerant from the compressor 206 and is adapted to condense the refrigerant. More specifically, the condenser 208 is adapted to cool the refrigerant that flows through the condenser 208. The condenser 208 is mounted directly above the radiator 108 so that the condenser 208 faces the radiator fan 110. The specific arrangement of the condenser 208 above the radiator 108 enables the condenser 208 to directly receive at least a portion of the flow of air generated by the radiator fan 110. Therefore, the condenser 208 is capable of being cooled by the radiator fan 110.

The at least one condenser fan 210 is mounted proximal to the condenser 208 so that the at least one condenser fan 210 also faces the condenser 208. It may be contemplated that the at least one condenser fan 210 may be mounted on either side of the condenser 208 and faces the condenser 208. The at least one condenser fan 210 may run on electrical energy from an energy source during abnormal operation of the radiator fan 110. The at least one condenser fan 210 discontinue to consume energy, when the radiator fan 110 is in normal operation. The at least one condenser fan 210 is positioned to selectively generate a flow of air over the condenser 208. Therefore, the condenser 208 is capable of being cooled by the at least one condenser fan 210.

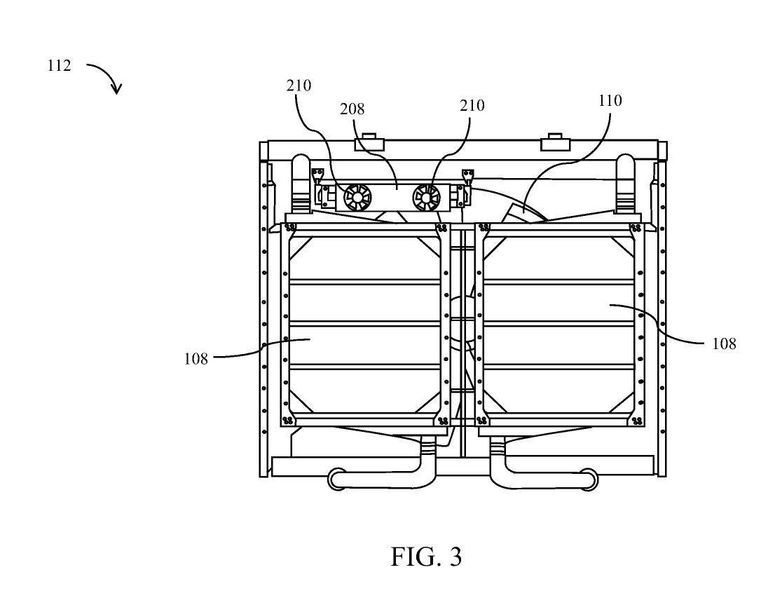

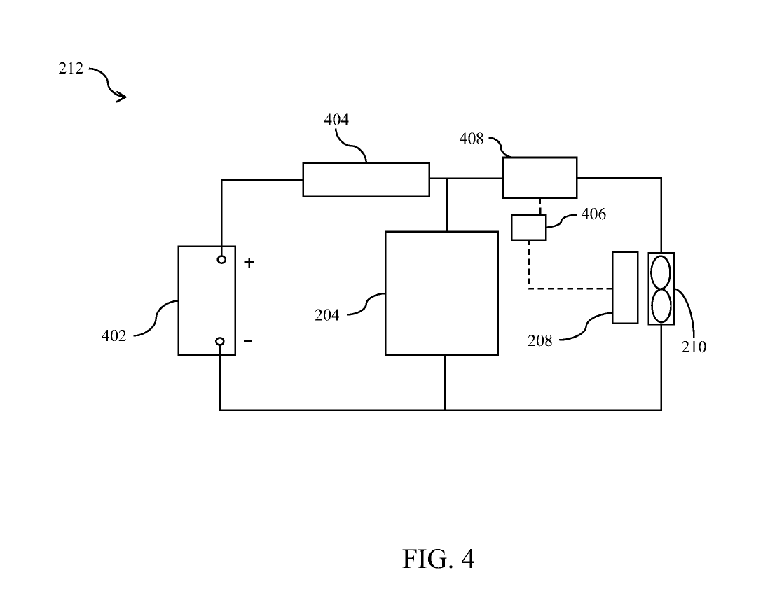

Referring to FIG. 3, there is shown the air conditioning system 112 that illustrates an arrangement of the condenser 208 and the at least one condenser fan 210 with the radiator 108. The condenser 208 is positioned so that the condenser 208 receives at least a portion of the flow of air generated by the radiator fan 110. Also, the at least one condenser fan 210 may be fixedly attached to the condenser 208 so that the flow of air generated by the at least one condenser fan 210 is directly received by the condenser 208. Therefore, the condenser 208 of the air conditioning system 112 may be cooled by both the radiator fan 110 and the at least one condenser fan 210. However, a simultaneous and continuous operation of both of the radiator fan 110 and the at least one condenser fan 210 may be unnecessary to efficiently cool the condenser 208. Therefore, a control system 212 (as shown in FIGS. 2 and 4) is installed to selectively control the at least one condenser fan 210, based on operational requirements of the condenser 208, as best seen in FIG. 4.

Referring to FIG. 4, there is shown the circuit diagram of the control system 212, in accordance with the concepts of the present disclosure. The control system 212 is adapted to selectively activate and/or deactivate the at least one condenser fan 210 based on operational requirements of the condenser 208. The operational requirements of the condenser 208 may be measured by measuring at least one of: an engine speed, a temperature of the condenser 208, and an air flow through the condenser 208. It may be noted that the engine speed corresponds to the speed of the radiator fan 110, and therefore indirectly corresponds to the air flow through the condenser 208. Hence, the engine speed may be measured to measure operational requirements of the condenser 208. The control system 212 includes an energy source 402, a power switch 404, a sensor 406, and a control unit 408.

The energy source 402 is connected in series with the power switch 404. The power switch 404 is a main switch that activates the air conditioning system 112, when actuated. The evaporator 204 is connected in parallel with the energy source 402 and the power switch 404. Therefore, the evaporator 204 is actuated as soon as the power switch 404 is actuated. Similarly, the at least one condenser fan 210 is connected in parallel to the energy source 402 and the power switch 404, separated by the control unit 408.

The sensor 406 is operably connected to at least one of: the condenser 208 and the engine 106. The sensor 406 is adapted to measure and raise a signal corresponding to the at least one of: the engine speed, the temperature of the condenser 208, and the air flow through the condenser 208.

In an embodiment, the sensor 406 may be a temperature sensor operably connected to the condenser 208. The sensor 406 may measure a temperature of the condenser 208 and raise a signal corresponding to the temperature of the condenser 208. In another embodiment, the sensor 406 may be an air flow sensor operably connected to the condenser 208. The sensor 406 is adapted to measure the airflow through the signal corresponding to the air flow through the condenser 208. In yet another embodiment, the sensor 406 may be a speed sensor operably connected to the engine 106. The sensor 406 is adapted to measure the airflow through the signal corresponding to the engine speed.

The control unit 408 is operably connected to the sensor 406 and is adapted to receive the signal generated by the sensor 406. The control unit 408 is adapted to activate and/or deactivate the at least one condenser fan 210 based on the signal received from the sensor 406. More specifically, the control unit 408 is adapted to compare the signal with a predetermined value and then activate and/or deactivate the at least one condenser fan 210 based on the comparison. For example, if the measured temperature is below the predetermined value, the control unit 408 deactivates the at least one condenser fan 210. Similarly, if the measured temperature is above the predetermined value, the control unit 408 activates the at least one condenser fan 210.

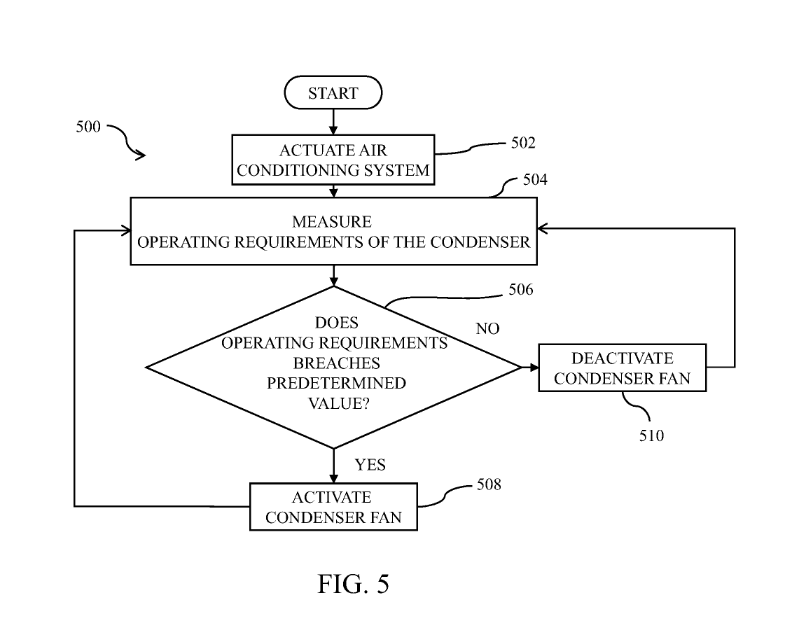

Referring to FIG. 5, a flow chart 500 depicts the steps of the control system 212 to control the operation of the at least one condenser fan 210. More specifically, the flow chart 500 depicts the steps of selective activation and deactivation of the at least one condenser fan 210.

The flow chart 500 initiates at step 502. At step 502, the power switch 404 of the air conditioning system 112 is turned on to actuate the air conditioning system 112. As soon as the step 502 is performed, various parts of the air conditioning system 112 are activated and the flow chart 500 proceeds to step 504.

At step 504, the sensor 406 measures the at least one of: the engine speed, the temperature of the condenser 208, and the air flow through the condenser 208 that corresponds to operational requirements of the condenser 208. Thereafter, the flow chart 500 proceeds to step 506.

At step 506, the control unit 408 compares the at least one of: the engine speed, the temperature, and the airflow measured by the sensor 406 with the predetermined value. If the at least one of: the engine speed, the temperature, and the air flow breaches the predetermined value, the control unit 408 activates the at least one condenser fan 208 at step 508. Also, if the at least one of: the engine speed, the temperature, and the air flow is within acceptable limits relative to the predetermined value, the control unit 408 deactivates the at least one condenser fan 208 at step 508.

Particularly, if the temperature of the condenser 208 is above the predetermined value, the control unit 408 activates the at least one condenser fan 208 at step 508. Conversely, if the temperature of the condenser 208 is below the predetermined value, the control unit 408 deactivates the at least one condenser fan 208, at step 510. Similarly, if the airflow of the condenser 208 is below the predetermined value, the control unit 408 activates the at least one condenser fan 208, at step 508. Also, if the airflow of the condenser 208 is above the predetermined value, the control unit 408 deactivates the at least one condenser fan 208, at step 510.

At step 508, the control unit 408 activates the at least one condenser fan 210 that cools the condenser 208. After completion of step 508, the flow chart 500 returns to step 504. Similarly, at step 510, the control unit 408 deactivates the at least one condenser fan 210 and returns to step 504.

### INDUSTRIAL APPLICABILITY

In operation, an operator may turn on the power switch 404 to actuate the air conditioning system 112 of the machine 100. As soon as the air conditioning system 112 is actuated, the refrigerant is circulated through the expansion valve 202, the evaporator 204, the compressor 206, and the condenser 208. In normal operation of the air conditioning system 112, the condenser 208 may become heated and may be required to be cooled.

While the machine 100 is in operation, the radiator fan 110 may be utilized to cool the condenser 208. The radiator fan 110 may cool the radiator 108 as well as the condenser 208 of the air conditioning system 112. Under heavy load operation of the air conditioning system 112, the radiator fan 110 alone may be insufficient to cool the condenser 208. Similarly, in non-operating conditions of the machine 100, the radiator fan 110 may not cool the condenser 208. In those conditions, the at least one condenser fan 210 may be required to cool the condenser 208. However, a simultaneous and continuous operation of both of the radiator fan 110 and the at least one condenser fan 210 may result in using more energy than is required to cool the condenser 208. Therefore, the control system 212 is positioned to selectively activate and deactivate the at least one condenser fan 210.

The sensor 406 continuously measures the at least one of: the engine speed, the temperature of the condenser 208, and the airflow through the condenser 208 and raises the signal. The control unit 408 receives the signal and compares the at least one of: the engine speed, the temperature of the condenser 208, and the airflow through the condenser 208 with the predetermined value. If the at least one of: the engine speed, the temperature, and the airflow breaches the predetermined value, the control unit 408 activates the at least one condenser fan 210. Similarly, if the at least one of: the engine speed, the temperature, and the airflow is within acceptable limits relative to the predetermined value, the control unit 408 deactivates the at least one condenser fan 210. When deactivated, the at least one condenser fan 210 discontinue to consume energy and therefore energy is conserved.

The specific arrangement and control of the at least one condenser fan 210 enables the at least one condenser fan 210 and the radiator fan 110 to cool the condenser 208 and save energy. This results in efficient operation and saves operational cost of the air conditioning system 112.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. An air conditioning system for a machine, the machine having an engine, a radiator operably connected to the engine, and a radiator fan for generating a flow of air over the radiator, the air conditioning system comprising:
a condenser for condensing a refrigerant, the condenser being structured and arranged to directly receive at least a portion of the flow of air generated by the radiator fan;
at least one condenser fan adapted to selectively generate a flow of air over the condenser;
a sensor configured to measure at least one of: an engine speed, a temperature of the condenser, and an air flow through the condenser; and
a control unit operably connected to the sensor, the control unit adapted to selectively control the at least one condenser fan based on the at least one of: the engine speed, the temperature of the condenser, and the air flow through the condenser measured by the sensor.
